(19) United States
(12) Patent Application Publication
(10) Pub. No.: US 2022/0031547 A1
(43) Pub. Date: Feb. 3, 2022

(54) HYGIENIC LINER FOR MEDICAL INFANT RESTRAINT DEVICE

(71) Applicants: Diane Morgan, Bristol, CT (US); Ramzi Alkass, Farmington, CT (US)

(72) Inventors: Diane Morgan, Bristol, CT (US); Ramzi Alkass, Farmington, CT (US)

(21) Appl. No.: 16/983,384

(22) Filed: Aug. 3, 2020

(51) Int. Cl. A61G 13/12

(52) U.S. Cl. CPC A61G 13/1295; A61G 2200/32; A61G 2200/14

(57) ABSTRACT

A liner for an infant holder having at least one recess includes a body having an upper surface, a lower surface, and a plurality of sidewalls extending between the lower surface and the upper surface. The lower surface and the plurality of sidewalls define at least one cavity receivable within the at least one recess of the infant holder.

### BACKGROUND OF THE INVENTION

The present disclosure relates to an infant holder for performing a medical procedure, and more specifically, a hygienic liner usable with the infant holder for performing a medical procedure thereon.

An infant holder is commonly used to perform a medical procedure on an infant. During such a procedure, the infant is positioned on a surface of the infant holder and one or more restraints are used to hold down the infant's arms and/or legs. In preparation of performing a medical procedure, the surface of the infant holder is typically sterilized manually, such as by wiping the surface with a disinfectant or cleaner. Similarly, after completion of a procedure, the surface of the infant holder is again manually disinfected. However, the openings formed in the infant holder for the restraints can prove difficult to clean. Additionally, chemicals such as iodine are commonly used during infant procedures and as a result, discolor or stain the surfaces of the infant holder, giving the infant holder a less than hygienic aesthetic appearance.

### BRIEF DESCRIPTION

According to one embodiment, a liner for an infant holder having at least one recess includes a body having an upper surface, a lower surface, and a plurality of sidewalls extending between the lower surface and the upper surface. The lower surface and the plurality of sidewalls define at least one cavity receivable within the at least one recess of the infant holder.

In addition to one or more of the features described above, or as an alternative, in further embodiments the at least one cavity is generally complementary in size and shape to the at least one recess of the infant holder.

In addition to one or more of the features described above, or as an alternative, in further embodiments the at least one cavity further comprises a first cavity configured to receive a torso of an infant and at least one second cavity configured to receive a leg of the infant.

In addition to one or more of the features described above, or as an alternative, in further embodiments the liner is formed from a plastic material.

In addition to one or more of the features described above, or as an alternative, in further embodiments the body further comprises an outwardly extending flange positionable in overlapping arrangement with an upper surface of the infant holder.

In addition to one or more of the features described above, or as an alternative, in further embodiments the outwardly extending flange is configured to extend beyond an edge of the infant holder.

In addition to one or more of the features described above, or as an alternative, in further embodiments comprising at least one restraint operably coupled to the liner.

In addition to one or more of the features described above, or as an alternative, in further embodiments the liner includes at least one opening associated with the at least one cavity, and at least one end of the restraint extends through the at least one opening.

In addition to one or more of the features described above, or as an alternative, in further embodiments the restraint is removably coupled to the body.

In addition to one or more of the features described above, or as an alternative, in further embodiments the restraint configured to be disposed of after a single use.

In addition to one or more of the features described above, or as an alternative, in further embodiments the restraint is permanently affixed to the body.

In addition to one or more of the features described above, or as an alternative, in further embodiments the restraint and the body of the liner are formed from a same material as the liner, and the restraint is integrally formed with the body.

In addition to one or more of the features described above, or as an alternative, in further embodiments the body further comprises one or more friction features formed on a bottom of the lower surface and configured to engage a surface of the infant holder.

According to another embodiment, an assembly includes an infant holder including a base having one or more recesses formed therein and a disposable liner having at least one cavity. The liner is positionable in overlapping arrangement with the infant holder such that the at least one cavity is nested within the one or more recesses.

In addition to one or more of the features described above, or as an alternative, in further embodiments the at least one cavity is generally complementary in at least one of size and shape to the one or more recesses.

In addition to one or more of the features described above, or as an alternative, in further embodiments the one or more recesses include a torso recess and at least one leg recess, and the at least one cavity further comprises a first cavity configured to receive a torso of an infant and at least one second cavity configured to receive a leg of the infant, the first cavity being receivable within the torso recess and the at least one second cavity being receivable within the at least one leg recess.

In addition to one or more of the features described above, or as an alternative, in further embodiments comprising at least one restraint operatively associated with the at least one cavity.

In addition to one or more of the features described above, or as an alternative, in further embodiments the restraint is coupled to the infant holder.

In addition to one or more of the features described above, or as an alternative, in further embodiments the liner is formed from a plastic material.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an example of an infant holder for performing a medical procedure;

FIGS. 2A-2C are various view of a liner suitable for use with an infant holder according to an embodiment; and

FIG. 3A is a perspective view of the liner installed about an infant holder according to an embodiment; and

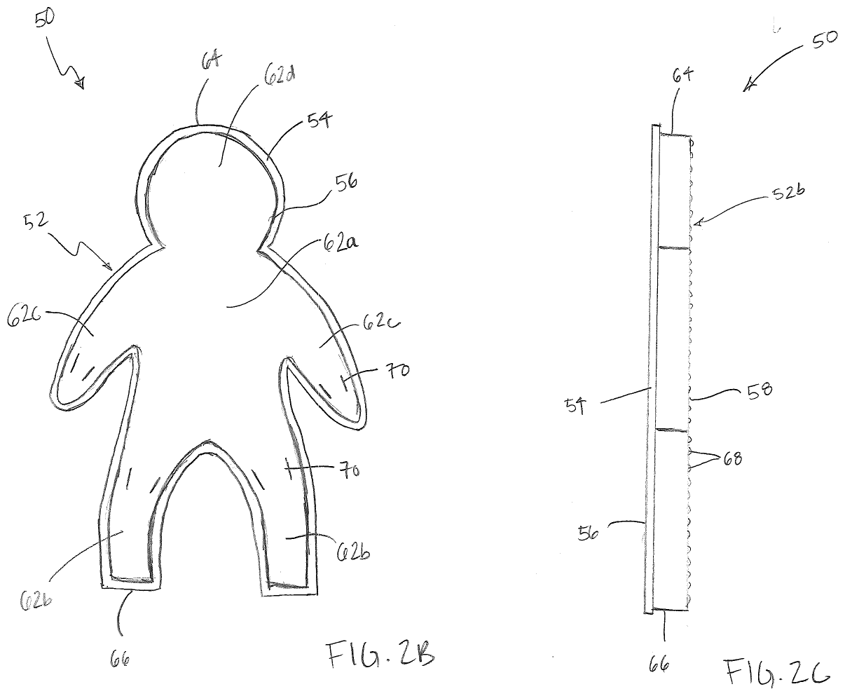

FIG. 3B is a cross-sectional view of the assembly of FIG. 3A, taken along line X-X according to an embodiment.

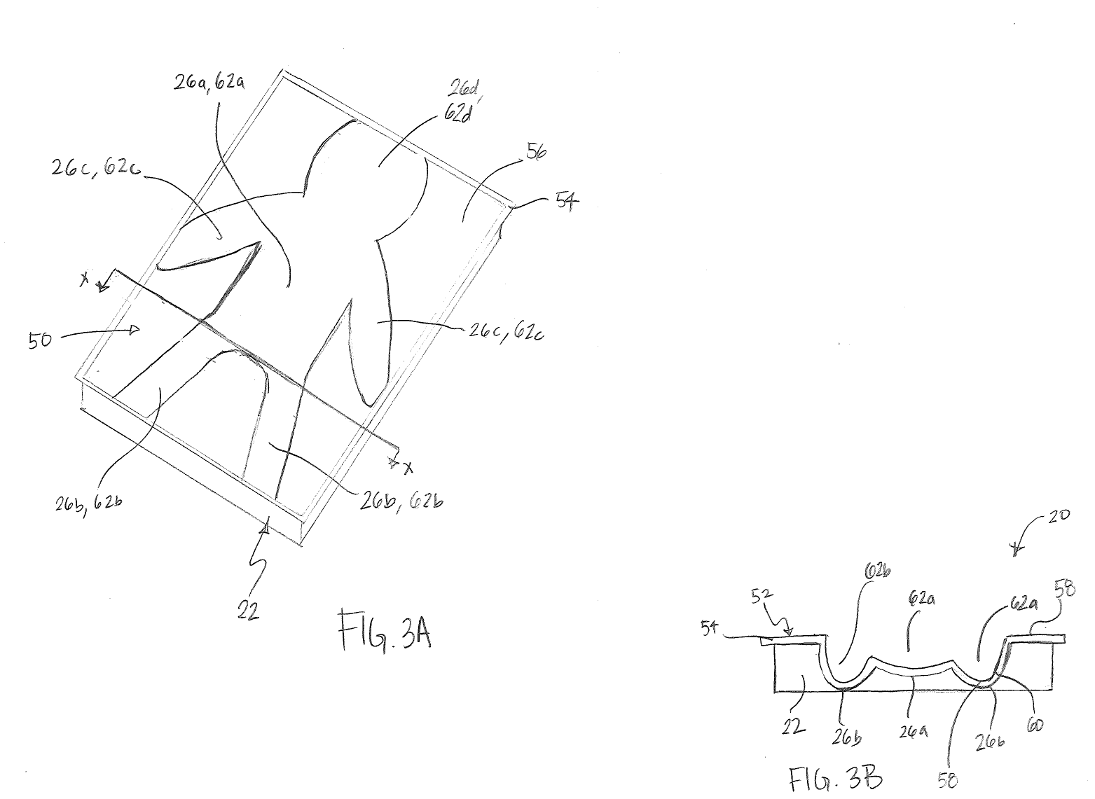

The detailed description explains embodiments of the invention, together with advantages and features, by way of example with reference to the drawings.

### DETAILED DESCRIPTION OF THE INVENTION

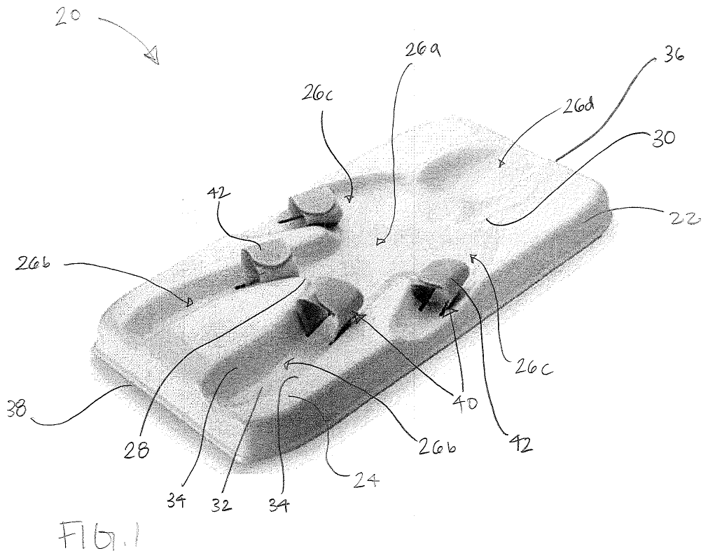

Referring now to the FIG. 1, an example of an infant holder, such as usable to stabilize an infant during a circumcision and/or another medical procedure for example, is illustrated. As shown, the infant holder 20 includes a base 22 formed from any suitable material, such as plastic for example. Although the base 22 is shown as being generally rectangular in shape, embodiments where the base 22 has another shape or configuration are also contemplated herein.

As shown, the base 22 of the infant holder 20 has a substantially flat or planar upper surface 24. Further, one or more recesses or depressions may be formed in the upper surface 24 of the base 22. The one or more recesses are configured to receive and support all of a portion of a body of an infant. The size, shape, and depth of the one or more recesses may vary.

In the illustrated, non-limiting embodiment, the base 22 includes a central recess 26a in which an infant's torso is to be positioned, and two divergent elongated recesses 26b extending from a first end 28 of the central recess 26a for receiving an infant's legs. Additionally, the base 22 may include two elongated recesses 26c located at opposite sides of the central recess 26a, such as near the second end 30 of the central recess 26a. These opposed elongated recesses 26c may be intended to receive and support an infant's arms. Although the elongated arm recesses 26c are shown extending generally downwardly, toward the leg recesses 26b, embodiments where the arm recesses 26c extend upwardly, beyond the second end 30 of the central recess 26a, are also within the scope of the disclosure. A head recess 26d in which an infant's head is located, may be arranged adjacent the second end 30 of the central recess 26a.

Each recess 26a-26d typically includes a bottom 32 and at least one sidewall 34 extending between the bottom 32 and the upper surface 24 of the base 22. In an embodiment, the at least one sidewall 34 of each recess 26a-26d extends around one or more sides of the portion of an infant's body received therein to provide lateral restraint against physical movement of the body portions. The depth of the recess 26a-26d and/or the height of the sidewalls 34 of a recess 26a-26d may vary based on the appendage associated with each recess 26a-26d. An example of such an infant holder 20 is Olympic Medical or Natus Newborn Care Olympic Circumstraint™.

It should be understood that the infant holder 20 and the recesses 26a-26d formed therein as illustrated and described herein are intended as an example only, and that in other embodiments, an infant holder 20 having any suitable shape and including any number of recesses is within the scope of the disclosure. For example, an infant holder having only a portion of the recesses described herein, such as a torso recess and two leg recesses for example, or alternatively, including additional recesses is contemplated herein. Further, although the plurality of recesses 26a-26d are shown as being connected or integrally formed to define a single large recess, embodiments where one or more of the recesses is not connected to another recess are also within the scope of the disclosure.

The base 22 and/or at least one recess 26a-26d may be formed such that when an infant is positioned within the recesses 26a-26d, the infant is laid generally flat, within a plane. However, in other embodiments, the base 22 and/or at least one recess 26a-26d may be configured such that the infant's head is arranged at an incline relative to the infant's legs. In such embodiments, the thickness of a first end 36 of the base 22 may be greater than the thickness at a second end 38 of the base 22. Alternatively, or in addition, the depth of the recesses 26a-26d may vary. For example, the depth of the recesses 26b configured to receive the infant's legs may have a depth greater than the recess 26a, 26d configured to receive the infant's head and/or torso.

A restraint 40 may be associated with one or more of the recesses 26a-26d of the infant holder. In the illustrated, non-limiting embodiment, a first set of restraints 40 is positioned near a lower portion of each of the arm recesses 26c and second set of restraints 40 are positioned near an upper end of each of the leg recesses 26b. However, embodiments including one or more restraints 40 associated with one or more of the recesses 26a-26d formed in the base 22 are contemplated herein. In an embodiment, any combination of a torso restraint, a head restraint, a leg restraint, and an arm restraint are within the scope of the disclosure.

In the illustrated, non-limiting embodiment, each restraint 40 includes a strap 42 extendable through a pair of openings formed in the base 22 adjacent or within a recess 26a-26d. When an infant is positioned on the infant holder 20, such as within the recesses 26a-26d for example, the two ends of the strap 42 are affixed to one another about a corresponding appendage to restrict movement of that appendage relative to the infant holder. Alternatively, a strap may be affixed at a first end and may be selectively connectable to a connector located on the base 22 adjacent an opposite side of a recess. In such embodiments, the one or more straps 42 may include a hook and loop type attachment, such as Velcro® for example, adjustable fasteners, or any other suitable means for connecting an end of the strap to a respective connector or for connecting the ends of the strap 42 together. However, it should be understood that any suitable restraint device capable of limiting movement of an appendage relative to a corresponding recess is within the scope of the disclosure.

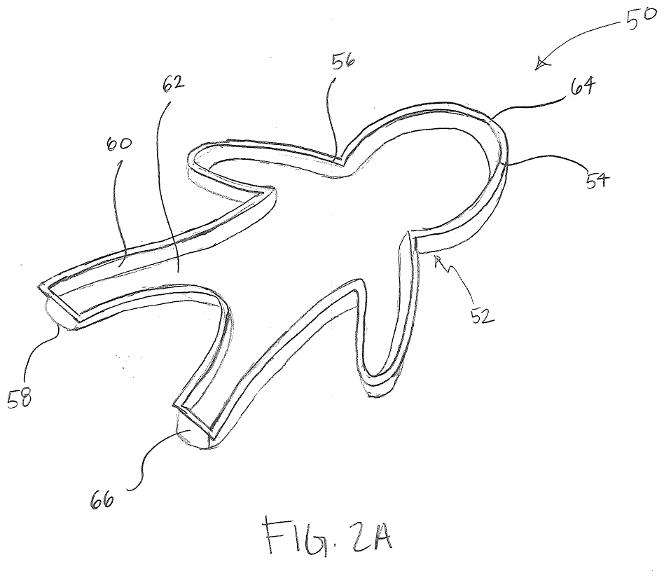

With reference now to FIG. 2A-2C, a liner 50 suitable for use with an infant holder, such as infant holder 20 for example, is illustrated according to an embodiment. As shown, the liner 50 includes a deformable resilient liner body 52 formed from any non-porous material suitable for use in a medical application, such as plastic for example. In an embodiment, the liner 50 is intended for a single use, such as during a medical procedure on a single patient for example and is therefore disposable. However, embodiments where the liner 50 may be reused after sterilization are also contemplated herein.

The liner body 52 may have a length and/or width generally equal to the base 22 of the infant holder 20. In an embodiment, the liner body 52 includes an outwardly extending flange 54 formed about all or at least a portion of an outer perimeter of the liner body 52. When the liner body 52 is installed about the infant holder 20, the flange 54 is arranged in overlapping arrangement with the upper surface 24 of the infant holder 20. Further, in some embodiments, the flange 54 is configured to extend beyond an edge of the infant holder 20 and therefore provides a mechanism to easily grasp and maneuver the liner 50 relative to the infant holder 20.

The liner 50 is nestable with the infant holder 20. As shown, the liner body 52 includes a first upper surface 56, a second lower surface 58 vertically offset from the first upper surface 56, and a plurality of sidewalls 60 extending between the upper and lower surfaces 56, 58. Together the sidewalls 60 and the lower surface 58 cooperate to define one or more cavities 62 within the liner body 52. In an embodiment, the shape and size of the one or more cavities 62 formed in the liner body 52 is generally complementary in size and/or shape to the one or more recesses 26a-26d formed in a corresponding infant holder 20. As a result, the one or more cavities 62 formed in the liner body 52 are generally nestable within the one or more respective recesses 26a-26d of the infant holder 20. For example, as best shown in FIG. 2B, the liner body 52 includes a central cavity 62a, two leg cavities 62b, two arm cavities 62c, and a head cavity 62d complementary to and receivable within the torso recess 26a, the two leg recesses 26b, the two arm recesses 26c, and the head recess 26d, respectively. The one or more cavities 62 formed in the liner body 52 may be configured to capture and retain liquids, such as body liquids or alternatively liquids applied during the medical procedure, therein.

When installing the liner 50 about the infant holder 20, a first end 64 of the liner body 52 is arranged adjacent the first end 36 of infant holder 20 and the second end 66 of the liner body 52 is positioned adjacent the second end 66 of the infant holder. The one or more cavities 62a-62d of the liner body 52 are aligned with and inserted into the one or more recesses 26a-26d of the infant holder 20 in a nested configuration. In this nested configuration, the plurality of sidewalls 60 of the liner body 52 and the lower surface 58 of the liner body 52 are generally arranged within the recesses 26a-26d of the infant holder 20. In an embodiment, the size of the cavities 62a-62d formed in the liner body 52 may be equal to or slightly smaller than the recesses 26a-26d such that the lower surface 58 and sidewalls 60 of each cavity 62a-62d are received within and contact the lower surface 32 and the sidewalls 34 of the recesses 26a-26d of the infant holder 20.

Although the liner 50 is shown as being retained in position relative to the infant holder 20 via the contour of the cavities 62a-62d and recesses 26a-26d, respectively, in an embodiment, one or more clips or other coupling mechanisms may be used to removably affix the liner 50 to the infant holder 20. Alternatively, or in addition, one or more features 68 (see FIG. 2C), such as ridges or other protrusions for example, may be formed on the bottom of the lower surface 58 of the liner 50, to create friction and restrict movement of the liner body 52 relative to the recesses 26a-26d.

In an embodiment, best shown in FIG. 2B, one or more openings 70 are formed in the liner body 52. The one or more openings 70 are positioned to align with the adjacent openings formed in the infant holder 20 for each of the restraints 40. By including openings 70 in the liner 50, the restraints 40 of the infant holder 20 can be manipulated to extend through the liner body 52 for easy access thereto when the liner 50 is installed onto the upper surface 24 of the infant holder 20.

In another embodiment, one or more restraints 40 may be connected to or associated directly with the liner 50 in place of the infant holder 20. In such embodiments, a liner 50 having restraints already affixed thereto may be sold as a ready-to-use assembly that can be disposed of in its entirety after each surgical procedure. In such embodiments, the restraints 40 may simply extend through the openings 70 formed in the liner body 52, as described above. Alternatively, a restraint 40 may be affixed to the liner body 52, such as via a weld or heat seal for example. In yet another embodiment, the liner 50 may include restraint members formed from the same material as the liner body 52. In such embodiments, the restraints 40 may be integrally formed with the liner body 52, such as during a thermoforming process for example.

To use a liner 50 and infant holder 20 to perform a medical procedure as illustrated and described herein, the liner 50 is positioned such that the cavities 62a-62d of the liner 50 are arranged within the respective recesses 26a-26d of the infant holder 20. The liner 50 may, but need not be, affixed to the infant holder 20 via a coupling mechanism (not shown). An infant is then positioned on the liner 50, with one or more appendages received within a corresponding cavity 62a-62d. The restraints 40 of the infant holder 20 and/or liner 50 are then fastened about the respective appendages to restrict movement thereof, and the procedure may be performed. Upon completion, the liner 50 can be separated from the infant holder 20 and thrown away. In some embodiments, the restraints 40 may also be disposed of.

By using a liner 50 as illustrated and described herein in conjunction with the infant holder 20, the time required to prepare the infant holder 20 for each use is drastically reduced. Further, because the liner forms a hygienic protective barrier between the infant and the infant holder 20 during the procedure, the contamination of the infant holder 20, and therefore the time required to sterilize and/or sanitize the infant holder 20 after is each use is reduced or minimized. This will accordingly results in enhanced control against the spread of bacteria and infection.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A liner for an infant holder having at least one recess comprising:
a body having an upper surface, a lower surface, and a plurality of sidewalls extending between the lower surface and the upper surface;
wherein the lower surface and the plurality of sidewalls define at least one cavity, the at least one cavity being receivable within the at least one recess of the infant holder.

2. The liner of claim 1, wherein the at least one cavity is generally complementary in size and shape to the at least one recess of the infant holder.

3. The liner of claim 1, wherein the at least one cavity further comprises a first cavity configured to receive a torso of an infant and at least one second cavity configured to receive a leg of the infant.

4. The liner of claim 1, wherein the liner is formed from a plastic material.

5. The liner of claim 1, wherein the body further comprises an outwardly extending flange positionable in overlapping arrangement with an upper surface of the infant holder.

6. The liner of claim 1, wherein the outwardly extending flange is configured to extend beyond an edge of the infant holder.

7. The liner of claim 1, further comprising at least one restraint operably coupled to the liner.

8. The liner of claim 7, wherein the liner includes at least one opening associated with the at least one cavity, and at least one end of the restraint extends through the at least one opening.

9. The liner of claim 7, wherein the restraint is removably coupled to the body.

10. The liner of claim 7, wherein the restraint configured to be disposed of after a single use.

11. The liner of claim 5, wherein the restraint is permanently affixed to the body.

12. The liner of claim 11, wherein the restraint and the body of the liner are formed from a same material as the liner, and the restraint is integrally formed with the body.

13. The liner of claim 1, wherein the body further comprises one or more friction features formed on a bottom of the lower surface and configured to engage a surface of the infant holder.

14. An assembly comprising:
an infant holder including a base having one or more recesses formed therein; and
a disposable liner having at least one cavity, the liner being positionable in overlapping arrangement with the infant holder such that the at least one cavity is nested within the one or more recesses.

15. The assembly of claim 14, wherein the at least one cavity is generally complementary in at least one of size and shape to the one or more recesses.

16. The assembly of claim 14, wherein the one or more recesses include a torso recess and at least one leg recess, and the at least one cavity further comprises a first cavity configured to receive a torso of an infant and at least one second cavity configured to receive a leg of the infant, the first cavity being receivable within the torso recess and the at least one second cavity being receivable within the at least one leg recess.

17. The assembly of claim 14, further comprising at least one restraint operatively associated with the at least one cavity.

18. The assembly of claim 16, wherein the restraint is coupled to the infant holder.

19. The assembly of claim 14, wherein the liner is formed from a plastic material.
